(19) United States
(12) Patent Application Publication
(10) Pub. No.: US 2005/0174609 A1
(43) Pub. Date: Aug. 11, 2005

(54) System for selecting digital printers by geographical location

(75) Inventor: Barry J. Thurlow, Luton (GB)

Correspondence Address: Patent Documentation Center;Xerox Corporation,, Xerox Square 20th Floor, 100 Clinton Ave. S., Rochester, NY, 14644, US

(73) Assignee: Xerox Corporation

(21) Appl. No.: 10/776,831

(22) Filed: Feb. 11, 2004

(51) Int. Cl. H04N 1/00

(52) U.S. Cl. 358/425

(57) ABSTRACT

When a user of a computer seeks a printer having certain capabilities among a large population of printers dispersed over a large geographical area, the user consults a substantially open database of geographical data about each of the population of printers. Relational data is used with the geographical data to determine an effective distance of each suitable printer to a predetermined location. The effective distance determination can take into account distances within a building, or among different buildings.

### TECHNICAL FIELD

The present disclosure relates to digital printing apparatus (“printers”), especially the selection and operation of one of a large population of printers dispersed over a wide geographical area.

### BACKGROUND

Digital printing of documents created and stored on a computer is well known. A human user wishing to print out a document on his computer sends data reflective of the document to a target printer. In network-based printing, the user's computer must identify a target printer by a network address, and then communicate with the printer through a network protocol.

In a context of a large population of printers, spread over a wide geographical area, receiving documents from portable computers, which may be brought into a particular building by a user on a short-term basis, finding a “handy” printer may present a problem. Printers within an unfamiliar building may be in public areas such as hallways, in private offices, or in special secure areas. Among the population of printers may be machines with different capabilities, such as color printing; stapling, binding, or hole punching (generally, “finishing”); or speed or volume limitations. If a first printer initially selected for a particular use is found to be unsuitable, it would be desirable to locate a second printer, suitably close to the first printer, which may be capable of handling the job.

### PRIOR ART

U.S. Pat. No. 6,665,712 discloses using wireless devices, associated with various printers in a large environment, to locate individual printers.

### SUMMARY

There is provided a method of operating a plurality of printers, comprising retaining geographical data for each of the plurality of printers, and retaining relational data relating to the geographical data of the plurality of printers. The relational data is useful in determining an effective distance between a printer and a predetermined location.

### BRIEF DESCRIPTION OF THE DRAWINGS

FIG. 1 is a plan view of a portion of a building, illustrating the operation of one embodiment.

FIG. 2 is a simple flow-chart showing the basic operations associated with a database of information about a population of printers.

FIG. 3 is an example window, as would be shown on a user interface associated with a computer.

### DETAILED DESCRIPTION

As used herein, the term “printer” shall be construed broadly, to encompass any piece of office equipment that in any way processes digital image data, such as a digital copier, printer, facsimile, input scanner, or any machine performing one or more of these functions. Also as used herein, the term “computer” shall be construed broadly, to encompass any device which can act as a source of image data in any format, such as a PC, laptop, PDA, digital camera, wireless phone, or any machine performing any one or more of these functions.

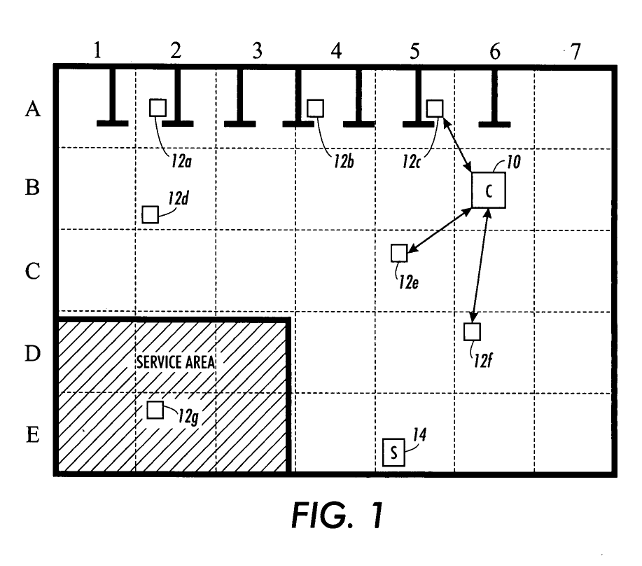

FIG. 1 is a plan view of a portion of a building, illustrating the operation of one embodiment. For purposes of this example, the plan view is organized in a grid, in which any part of the building can be located by coordinates, which are shown along the left and top edges of the Figure. Such a grid can be purely arbitrary for a particular purpose, or can relate in any way, fully or indirectly, to a larger coordinate system, such as that provided by the Global Positioning System (GPS). A useable “rough” grid system could also be derived from, for example, office or cubicle numbers in a building. Also, although the Figure shows a coordinate system within a single building, it is possible to extend essentially a single grid or coordinate system over multiple floors of a building, numerous buildings, or over a large geographical area.

If a user of a computer 10, at a certain location within the building as shown, wants to originate and send a job to a printer in the building, there is a population of printers available, shown as 12a-12g. However, various printers differ by both location and capabilities. Such capabilities, which can be summarized as “capability data” associated with the printer, may include the available finishing options, speed or volume limitations, color capability, read or write from a CD or disc, special characters such as MICR or barcodes, presence of special types of print media, etc. Any of these capabilities may make one printer more or less desirable in a particular situation.

Further, each printer has associated therewith a location, or more broadly, what can be called “geographical data.” Geographical data includes not only the identified location of the printer, such as definable by the grid and coordinate system shown in the Figure, but, also, information about whether the printer is in a “public” area, such as a hallway; a “private” area, such as an office; or a “secure” area, having special access restrictions. In the FIG. 1 example, printers 12a-12c are each in private offices; 12d-f are in public areas; and 12g is in a secure area. A user may need to know whether a certain nearby printer is in a public, private, or secure space.

According to this embodiment, a user of computer 10 in for example grid coordinates B6 will want to know which printers having suitable capabilities are closely or otherwise conveniently located relative to the computer 10. To obtain the desired information, the present embodiment retains, in a largely accessible database, both capability data and geographical data about a population of printers such as 12a-12g. The database can reside in a computer such as 10, or be accessed as needed from a server 14 within the building (indeed, the server 14 may retain capability data and geographical data for a huge population of printers all over the world, such as for a multinational corporation). The database may be updated on a regular and frequent basis, through generally known means, to reflect not only the current list of printers available on a network, but also temporary statuses of individual printers, such as being down or out of paper, etc.

Further in this embodiment, there is retained in a database, such as in server 14, what can be called “relational data.” Relational data is data with which the geographical data of a printer can interact, useful in making determinations about the relative positions of the printer and any predetermined location. For example, if the computer 10 is at grid coordinates B6, the public printers 12d, 12e, and 12f are, as would be known by the geographical data, at coordinates B2, C5, and D6 respectively. An algorithm within the relational data takes these coordinates and determines that printer 12d is four “squares” away from the computer 10 at B6; printer 12e is one square away; and printer 12f is two squares away. (The spatial resolution of the determination, here in terms of “squares” in the grid, could also be in feet or meters, or could be roughly derived from, for example, office or cubicle numbers, as needed in a given practical context.)

The relational data can take into account physical reality which is helpful in determining an effective distance between a computer and a plurality of printers. Examples of how such relational data would work are as follows. Within a building, certain grid coordinates (or other numbers, such as office numbers) may be associated with different floors of the building; the relational data would reflect printers being on different floors, and an algorithm could be used to add an artificial cost reflecting having to go to a different floor between a computer and a printer. Data associated with individual printers state that one printer is in a building A and another printer is in a building B. Further relational data could retain the fact that, for instance, building A and building B are connected by a pedestrian bridge, while a building C is 100 yards away from building A and a building D is 50 miles from building A; this information is useful in determining relative or effective distances among printers. Within the relational data, the determination of whether a printer is “near” a computer or other predetermined location can be made dependent on the size and capabilities of a printer, and/or the size and requirements of a print job: a person may not wish to leave a building, or move more than fifty feet, to pick up prints from a desktop ink-jet printer; whereas a person would be willing to travel, for instance, anywhere within a county to pick up a large job having a special binding.

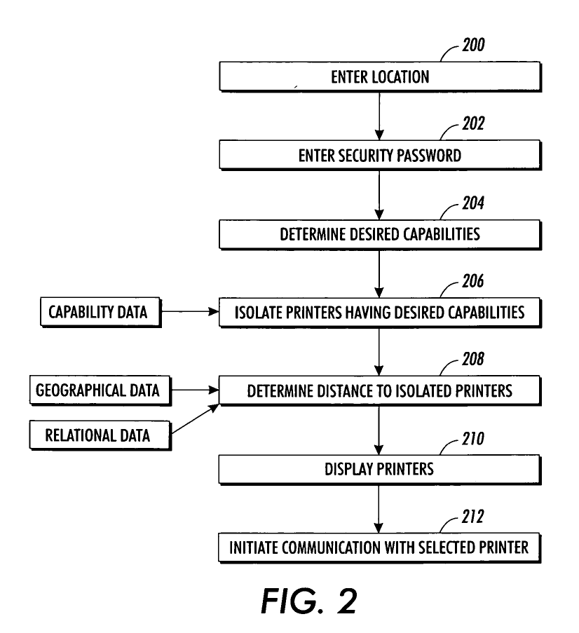

FIG. 2 is a simple flow-chart showing the basic operations associated with a database of information about a population of printers. The user queries (step 200 in FIG. 2) what printers, suitable for a particular purpose (i.e., having certain capability data associated therewith) are near some predetermined location. The “predetermined location” may be where the computer 10 happens to be at the moment, or could be some other location, such as where the user of computer 10 would like another person to pick up the print job; as such the predetermined location could be in another building or in another country. In another embodiment, the location of the computer itself could be automatically determined, such as through a GPS system. The predetermined location can be expressed using consistent terminology, such as building names and grid coordinates, as is used in the geographical data associated with the population of printers.

The database, in server 14 or elsewhere, can be provided with various security features as desired; in one embodiment, data about only a subset of printers may be made available with certain low security constraints, with more printers being made available (or displayed) only in response to a higher security procedure, such as entering further passwords (step 202). Once the predetermined location is entered, the database, such as in server 14, is accessed, and the geographical data, capability data, and relational data of a population of available printers is made available.

Once the predetermined location is entered, the desired printer capabilities can be entered (step 204); alternatively, such printer capabilities can readily be inferred from the requirements of a print job (e.g., if the job requires stapling, then stapling is a capability that must be sought). Up to this point a simple exclusion algorithm can be used in the server to isolate, from the initial printer population, the subset of printers capable of carrying out the desired job (or, more broadly, having the desired capabilities), as at step 206.

Once the subset of capable printers is identified, the next step is to determine the effective distance of each of the printers to the predetermined location, and at this point the relational data, interacting with the geographical data, is brought into play (step 208). Algorithms (which are themselves part of the relational data) for determining the printers which are “near” the predetermined location can follow any number of strategies. First, the relational data can isolate those printers which are in the same building as the predetermined location, find the printers with the closest floor and grid coordinates (or equivalents thereof) and then list some “near” printers, such as in order of effective distance to the predetermined location. As mentioned above, the determination of an effective distance to the predetermined location can include artificial costs that take into account other factors besides mere distance, such as changing floors, or whether the printer is in private office versus a public hallway.

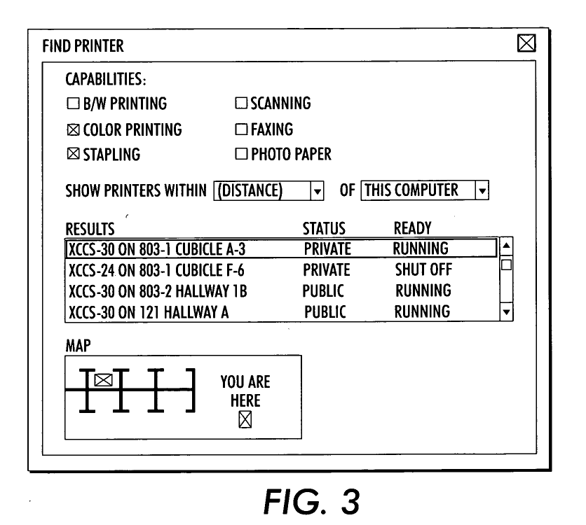

FIG. 3 is an example window, as would be shown on a user interface associated with a computer such as 10 in FIG. 1, that would result from a query entered by the user of the computer 10. Once the effective distances to the predetermined location are determined, a list of results are displayed to the user (step 210) through the window, as shown in FIG. 3. Among these results are description of whether the listed printers are public, private, secure, etc. In some arrangements, it may be desirable simply to not display (or to display only to computers of privileged users) any printers which are in secure areas. The window can also display whether the printers are in useable condition (such as having paper, not being down) at the moment; such information is obtainable through systems such as Xerox® CentreWare®.

In one embodiment, there can be displayed on the user's computer only those printers which are both capable of providing the desired print job and currently available for use; broadly speaking, only those printers which are “suitable.” In effect, what happens in such a case is that it is determined that one printer in the population of printers is found unsuitable for a particular job, and therefore a second printer is selected for display. This second printer is thus identified as a “backup” to the first printer, using geographical and relational data.

The display can also include one or more maps at various scales, as shown in FIG. 3; such maps can be derived by information obtained via GPS data. The window can be arranged to allow the user to click on a printer he selects, thus initiating network communication between the computer and the selected printer, in a manner generally known in the art (step 212 in FIG. 2).

In various alternate embodiments, the geographical data associated with each printer can be stored within each printer and pulled from the printer's memory to create or interact with the relational data in the server 14 or the user's computer 12 as required. From a practical viewpoint, an easy place to enter a printer's geographical data and basic capability data would be at the printer itself, such as at printer setup; in some cases even the relational data could be entered at the printer. Only those printers that do not facilitate such data entry, such as smaller printers which do not have user interfaces, would require an additional step to access and update the database on the server 14. Even where a central server such as 14 is used to store the geographical data and the relational data, it could still be of advantage for the server to read that data from each printer, either whenever a new printer is set up and/or at predetermined “network discovery” times.

The claims, as originally presented and as they may be amended, encompass variations, alternatives, modifications, improvements, equivalents, and substantial equivalents of the embodiments and teachings disclosed herein, including those that are presently unforeseen or unappreciated, and that, for example, may arise from applicants/patentees and others.

1. A method of operating a plurality of printers, comprising:
retaining geographical data for each of the plurality of printers; and
retaining relational data relating to the geographical data of the plurality of printers, the relational data being useful in determining an effective distance between a printer and a predetermined location.

2. The method of claim 1, the relational data being retained in a server, the server being accessible to a computer originating a job to be printed.

3. The method of claim 1, further comprising
determining that a first printer of the plurality of printers is unsuitable for a purpose; and
using the relational data to find a second printer of a predetermined geographical relationship to the first printer.

4. The method of claim 1, further comprising
determining an effective distance of at least one printer to a predetermined location, using the geographical data and the relational data.

5. The method of claim 1, further comprising
determining an effective distance of at least two printers to a predetermined location, using the geographical data and the relational data; and
displaying information about at least one printer of the at least two printers.

6. The method of claim 5, further comprising
displaying an indication that one printer of the at least two printers has a smaller effective distance to the predetermined location than another of the at least two printers.

7. The method of claim 4, further comprising
displaying a map showing a location of the at least one printer.

8. The method of claim 1, the relational data relating to a grid system.

9. The method of claim 1, the relational data taking into account distances between buildings in which printers of the plurality of printers reside.

10. The method of claim 1, the relational data taking into account different floors within a building in which printers of the plurality of printers reside.

11. The method of claim 1, the relational data taking into account capability data of a printer to determine whether the printer is near a predetermined location.

12. The method of claim 1, the relational data taking into account a requirement of a desired print job to determine whether the printer is near a predetermined location.

13. The method of claim 1, the geographical data for each printer including data about public accessibility of the printer.

14. The method of claim 1, the geographical data for each printer including data about security properties of the printer.

15. The method of claim 1, the geographical data for each printer including data about a building in which the printer is located.

16. The method of claim 1, the geographical data for each printer including data about a location within a building in which the printer is located.

17. The method of claim 1, the geographical data for each printer including GPS-useable information describing a location of the printer.

18. The method of claim 1, the geographical data for each printer including grid coordinates.

19. The method of claim 1, further comprising
retaining capability data for each of the plurality of printers.

20. The method of claim 19, further comprising
determining whether a printer in the plurality of printers is suitable for a purpose, referring to the capability data of a printer in the plurality of printers.

21. The method of claim 19, the capability data for each printer including data about whether the printer can print in color.

22. The method of claim 19, the capability data for each printer including data about whether the printer can perform a desired finishing operation.

23. The method of claim 19, the capability data for each printer including data about whether the printer can output special characters.
